(19) United States
(12) Patent Application Publication
(10) Pub. No.: US 2026/0006659 A1
(43) Pub. Date: Jan. 1, 2026

(54) COMMUNICATION METHODS

(71) Applicant: INNOPEAK TECHNOLOGY, INC., Palo Alto, CA (US)

(72) Inventor: Marcus WONG, Palo Alto, CA (US)

(21) Appl. No.: 18/879,882

(22) PCT Filed: Aug. 10, 2023
(86) PCT No.: PCT/US2023/029932

§ 371 Date: Dec. 30, 2024

Related U.S. Application Data
(60) Provisional application No. 63/397,327, filed on Aug. 11, 2022.

(51) Int. Cl. H04W 76/14; H04W 12/033; H04W 88/04

(52) U.S. Cl. CPC H04W 76/14; H04W 12/033; H04W 88/04

(57) ABSTRACT

A communication method by a first user equipment (UE), includes: connecting, by the first UE having a first capability, to a relay; and communicating, by the first UE, with the second UE through the relay, wherein the second UE has a second capability different from the first capability.

### CROSS REFERENCE TO RELATED APPLICATIONS

This application is U.S. National Stage entry of International Application No. PCT/US2023/029932, filed on Aug. 10, 2023, which claims priority to U.S. Provisional Application No. 63/397,327, filed on Aug. 11, 2022, the entire disclosures of which are hereby incorporated by reference.

### TECHNICAL FIELD

The present disclosure relates to the field of communication systems, and more particularly, to communication methods.

### BACKGROUND

In current solutions, interworking between certain devices in a broadband network communicating with devices or accessing fifth generation (5G) services in 5G network is through a 5G residential gateway (5G-RG) or a fixed network residential gateway (FN-RG) in a wireline 5G access network.

The current solutions require that either the 5G-RG or the FN-RG be connected to a wireless access gateway function (W-AGF) in the wireline 5G network that is required to provide connectivity to the 5G network. Devices in the wireline network are assumed to be authenticated to the wireline network and any access to the 5G network may not be authenticated. Authentication to the 5G network happens on the 5G-RG or FN-RG level. Once devices in the wireline network is connected to the 5G network through the 5G-RG or the FN-RG, communication between that device and another device in the 5G network most likely occurs at an application layer and therefore bypasses the security 5G network put in place.

Therefore, there is a need for apparatuses and communication methods such as methods for secure communication between multiple user equipments (UEs) with different capabilities via UE-to-UE relay in 5G.

### SUMMARY

In a first aspect of the present disclosure, a communication method by a first UE includes

connecting, by the first UE having a first capability, to a relay and communicating, by the first UE, with the second UE through the relay, wherein the second UE has a second capability different from the first capability.

In a second aspect of the present disclosure, a communication method by a relay includes connecting, by the relay, to a first UE having a first capability, connecting, by the relay, to a second UE having a second capability different from the first capability, and enabling, by the relay, communication between the first UE and the second UE through the relay.

### BRIEF DESCRIPTION OF DRAWINGS

In order to illustrate the embodiments of the present disclosure or related art more clearly, the following figures will be described in the embodiments are briefly introduced. It is obvious that the drawings are merely some embodiments of the present disclosure, a person having ordinary skill in this field can obtain other figures according to these figures without paying the premise.

FIG. 1 is a block diagram of an example of wireless broadband network accessing fifth generation (5G).

FIG. 2 is a block diagram of first and second user equipments (UEs) and a relay of communication in a communication system according to an embodiment of the present disclosure.

FIG. 3 is a block diagram of first and second UEs and a relay of communication in a communication system according to an embodiment of the present disclosure.

FIG. 4 is a block diagram of first and second UEs communicating securely using different

encryption algorithms through a relay according to an embodiment of the present disclosure.

FIG. 5 is a block diagram of a communication system according to an embodiment of the present disclosure.

FIG. 6 is a block diagram of a communication system according to an embodiment of the present disclosure.

FIG. 7 is a flowchart illustrating a communication method performed by a communication system according to an embodiment of the present disclosure.

FIG. 8 is a block diagram of a first UE according to an embodiment of the present disclosure.

FIG. 9 is a block diagram of a first UE according to an embodiment of the present disclosure.

FIG. 10 is a flowchart illustrating a communication method performed by a first UE according to an embodiment of the present disclosure.

FIG. 11 is a block diagram of a relay according to an embodiment of the present disclosure.

FIG. 12 is a block diagram of a relay according to an embodiment of the present disclosure.

FIG. 13 is a flowchart illustrating a communication method performed by a relay according to an embodiment of the present disclosure.

FIG. 14 is a block diagram of an example of a computing device according to an embodiment of the present disclosure.

FIG. 15 is a block diagram of a communication system according to an embodiment of the present disclosure.

### DETAILED DESCRIPTION OF EMBODIMENTS

Embodiments of the present disclosure are described in detail with the technical matters. structural features, achieved objects, and effects with reference to the accompanying drawings as follows. Specifically, the terminologies in the embodiments of the present disclosure are merely for describing the purpose of the certain embodiment, but not to limit the disclosure.

The technical solutions of the embodiments of the present disclosure can be applied to various communication systems, such as a global system of mobile communication (GSM) system, a code division multiple access (CDMA) system, a wideband code division multiple access (WCDMA) system, a general packet radio service (GPRS, a long term evolution (LTE) system, a LTE frequency division duplex (FDD) system, a LTE time division duplex (TDD) system, an advanced long term evolution (LTE-A) system, a future 5th generation (5G) system (may also be called a new radio (NR) system, an evolution system of a NR system, a LTE-based access to unlicensed spectrum (LTE-U) system, a NR-based access to unlicensed spectrum (NR-U) system, an universal mobile telecommunication system (UMTS, a global interoperability for microwave access (WiMAX) communication system, wireless local area networks (WLAN), wireless fidelity (Wi-Fi), or other communication systems, etc.

Optionally, a user equipment (UE) mentioned in the embodiments of the present application may refer to an access terminal, a subscriber unit, a subscriber station, a mobile station, a remote station, a remote terminal, a mobile device, a user terminal, a terminal, a wireless communication device, a user agent, or a user device. The access terminal may be a cellular radio telephone, a cordless telephone, a session initiation protocol (SIP) telephone, a wireless local loop (WLL) station, a personal digital assistant (PDA, a handheld device with wireless communication functions, a computing device, other processing devices coupled with a wireless modem, an in-vehicle device, a wearable device, a terminal device in a future 5G network, a terminal device in a future evolved public land mobile network (PLMN), etc.

Optionally, the communication system in the embodiment of the present application may be applied to an unlicensed spectrum, where the unlicensed spectrum may also be considered as a shared spectrum, or the communication system in the embodiment of the present application may also be applied to a licensed spectrum, where the licensed spectrum can also be considered an unshared spectrum.

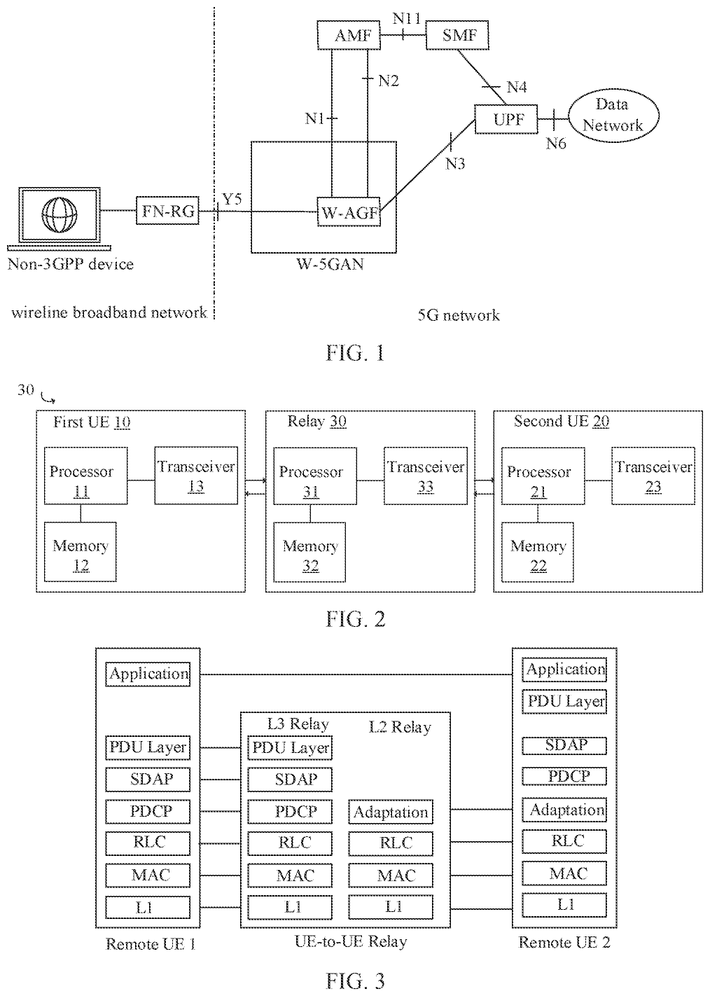

FIG. 1 illustrates an example of wireless broadband network accessing fifth generation (5G). FIG. 1 illustrates that, in current solutions, interworking between certain devices in a broadband network communicating with devices or accessing fifth generation (5G) services in 5G network is through a 5G residential gateway (5G-RG) or a fixed network residential gateway (FN-RG) in a wireline 5G access network.

FIG. 1 illustrates that, devices in the wireline network (e.g., wireline broadband network) wishing to access 5G network or communicating with UEs in a 5G connects to the 5G-RG or the FN-RG (in the above example). Either the 5G-RG or the FN-RG then translates the communication (i.e., control messages, user plane messages, etc.) from formats defined in the wireline network into formats understood by the 5G network before the traffic is routed to the appropriate destination in the 5G network. Conversely, the traffic flow from the 5G network to the wireline network may be translated from 5G format to a format only understood by the wireline network before routing the traffic to the wireline network.

The current solutions require that either the 5G-RG or the FN-RG be connected to a wireless access gateway function (W-AGF) in the wireline 5G network that is required to provide connectivity to the 5G network. Devices in the wireline network are assumed to be authenticated to the wireline network and any access to the 5G network may not be authenticated. Authentication to the 5G network happens on the 5G-RG or FN-RG level. Once devices in the wireline network is connected to the 5G network through the 5G-RG or the FN-RG, communication between that device and another device in the 5G network most likely occurs at an application layer and therefore bypasses the security 5G network put in place.

Therefore, there is a need for apparatuses and communication methods such as methods for secure communication between multiple user equipments (UEs) with different capabilities via UE-to-UE relay in 5G. The proposed some embodiments can allow multiple UEs with different capabilities to securely communicate with each other.

FIG. 2 illustrates that, in some embodiments, a first UE 10, a second UE 20, and a relay 30 of communication in a communication system 40. The communication system 40 includes the first UE 10, the second UE 20, and the relay 30. The first UE 10 may include a memory 12, a transceiver 13, and a processor 11 coupled to the memory 12 and the transceiver 13. The second UE 20 may include a memory 22, a transceiver 23, and a processor 21 coupled to the memory 22 and the transceiver 23. The relay 30 may include a memory 32, a transceiver 33, and a processor 31 coupled to the memory 32 and the transceiver 33. The processor 11, 21, or 31 may be configured to implement proposed functions, procedures and/or methods described in this description. Layers of radio interface protocol may be implemented in the processor 11, 21, or 31. The memory 12, 22, or 32 is operatively coupled with the processor 11, 21, or 31 and stores a variety of information to operate the processor 11, 21, or 31. The transceiver 13, 23, or 33 is operatively coupled with the processor 11, 21, or 31, and the transceiver 13, 23, or 33 transmits and/or receives a radio signal.

The processor 11, 21, or 31 may include application-specific integrated circuit (ASIC), other chipset, logic circuit and/or data processing device. The memory 12, 22, or 32 may include read-only memory (ROM), random access memory (RAM), flash memory, memory card, storage medium and/or other storage device. The transceiver 13, 23, or 33 may include baseband circuitry to process radio frequency signals. When the embodiments are implemented in software, the techniques described herein can be implemented with modules (e.g., procedures, functions, and so on) that perform the functions described herein. The modules can be stored in the memory 12, 22, or 32 and executed by the processor 11, 21, or 31. The memory 12, 22, or 32 can be implemented within the processor 11, 21, or 31 or external to the processor 11, 21, or 31 in which case those can be communicatively coupled to the processor 11, 21, or 31 via various means as is known in the art.

In some embodiments, the communication system 40 is configured to establish a first connection link between the relay 30 and the first UE 10 having a first capability, establish a second connection link between the relay 30 and the second UE 20 having a second capability different from the first capability, and enable communication between the first UE 10 and the second UE 20 through the relay 30. This can solve issues in the prior art and other issues. Further, the proposed some embodiments can allow multiple UEs with different capabilities to securely communicate with each other.

In some embodiments, the processor 11 having a first capability is connected to the relay 30 and is configured to communicate with the processor 21 through the relay 30, wherein the second UE 20 has a second capability different from the first capability. This can solve issues in the prior art and other issues. Further, the proposed some embodiments can allow multiple UEs with different capabilities to securely communicate with each other.

In some embodiments, the processor 31 is connected to the first UE 10 having a first capability and connected to the second UE 20 having a second capability different from the first capability. The processor 31 is configured to enable communication between the first UE 10 and the second UE 20 through the relay 30. This can solve issues in the prior art and other issues. Further, the proposed some embodiments can allow multiple UEs with different capabilities to securely communicate with each other.

FIG. 3 illustrates first and second UEs and a relay of communication in a communication system according to an embodiment of the present disclosure. FIG. 3 illustrates that, in some embodiments, the first and second UEs may be remote UE 1 and UE 2. The relay may be a UE-to-UE relay. FIG. 3 further illustrates that, in some embodiments, in a plane protocol stack, where an application, a packet data convergence protocol (PDCP) control protocol data unit (PDU) layer, a service data adaptation protocol (SDAP), a packet data convergence protocol (PDCP), a radio link control (RLC), a media access control (MAC), and a first layer (L1) (may also be called physical (PHY) layer) may be terminated in the remote UE1. In some embodiments, in a plane protocol stack, where an application, a PDU layer, a SDAP, a PDCP, an adaptation, an RLC, a MAC, and a L1 may be terminated in the remote UE2.

FIG. 3 illustrates that, in some embodiments, the UE-to-UE relay may include a first part and a second part. The first part may be a third layer relay (L3 relay). The second part may be a second layer relay (L2 relay). In some embodiments, in a plane protocol stack, where a PDU layer, a SDAP, a PDCP, an RLC, a MAC, and a L1 may be terminated in the L3 relay. In some embodiments, in a plane protocol stack, where an adaptation, an RLC, a MAC, and a L1 may be terminated in the L2 relay.

In an example, a L1 (PHY layer) provides transport services to higher layers (e.g., MAC, RLC, etc.). In an example, services and functions of a MAC may include mapping between logical channels and transport channels, multiplexing/demultiplexing of MAC service data units (SDUs) belonging to one or different logical channels into/from transport blocks (TBs) delivered to/from the L1, scheduling information reporting, error correction through hybrid automatic repeat request (HARQ) (e.g. one HARQ entity per carrier in case of carrier aggregation (CA)), priority handling between UEs by means of dynamic scheduling, priority handling between logical channels of one UE by means of logical channel prioritization, and/or padding. A MAC entity may support one or multiple numerologies and/or transmission timings. In an example, mapping restrictions in a logical channel prioritization may control which numerology and/or transmission timing a logical channel may use. In an example, an RLC may supports transparent mode (TM, unacknowledged mode (UM) and acknowledged mode (AM) transmission modes. The RLC configuration may be per logical channel with no dependency on numerologies and/or transmission time interval (TTI) durations. In an example, automatic repeat request (ARQ) may operate on any of the numerologies and/or TTI durations the logical channel is configured with. In an example, services and functions of the PDCP for the user plane may comprise sequence numbering, header compression, and decompression, transfer of user data, reordering and duplicate detection, PDCP PDU routing (e.g., in case of split bearers), retransmission of PDCP SDUs, ciphering, deciphering and integrity protection, PDCP SDU discard, PDCP re-establishment and data recovery for RLC AM, and/or duplication of PDCP PDUs. In an example, services and functions of SDAP may comprise mapping between a quality of service (QOS) flow and a data radio bearer. In an example, services and functions of SDAP may comprise mapping quality of service Indicator (QFI) in downlink (DL) and uplink (UL) packets. In an example, a protocol entity of SDAP may be configured for an individual PDU session.

FIG. 3 illustrates that some embodiments provide a mechanism of a wireless communication system for two UEs with different relay capabilities to communicate with each other when the UEs are out of network coverage. In some examples, the remote UE 1 connects to the UE-to-UE relay using a L3 relay service. The remote UE 2 connects to the UE-to-UE relay using L2 relay service. The remote UE 1 and the remote UE 2 communicate with each other through the UE-to-UE relay. The remote UE 1 communicates with the UE-to-UE relay in L3. The UE-to-UE relay converts information received from the remote UE 1 into L2 format. The UE-to-UE relay may forward the information in L2 format to the remote UE 2.

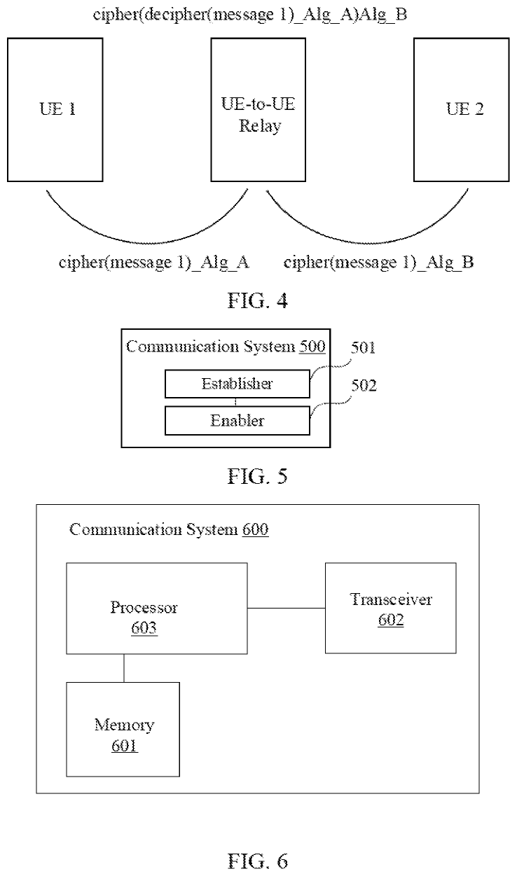

FIG. 4 illustrates first and second UEs communicating securely using different encryption algorithms through a relay according to an embodiment of the present disclosure. FIG. 4 illustrates that, in some embodiments, the first and second UEs may be remote UE 1 and UE 2. The relay may be a UE-to-UE relay. FIG. 4 further illustrates that, in some examples, when the remote UE 1 and the remote UE 2 support different security algorithms, the communication between the two UEs can also be secured in a hop-by-hop manner. The remote UE 1 encrypts the communication using a first encryption algorithm (such as encryption algorithm A) and sends the communication to the UE-to-UE relay. The UE-to-UE relay decrypts the communication from the remote UE 1 using the encryption algorithm A. The UE-to-UE relay re-encrypts the communication from the remote UE 1 using a second encryption algorithm (such as encryption algorithm B) and forwards the communication to the remote UE 2. The remote UE 2 decrypts the communication from the UE-to-UE relay using the encryption algorithm B.

FIG. 3 and FIG. 4 illustrate that, some embodiments allow two UEs with different technical capabilities (e.g., UE 1 is layer-2 relay capable only and UE 2 is layer-3 relay capable only) and different security capabilities (e.g., UE 1 is only capable of cipher algorithm A and UE 2 is only capable of cipher algorithm B) to securely communicate with each other.

FIG. 3 and FIG. 4 further illustrate that, in some embodiments, UEs have different capabilities, for example, UE 1 may only support layer 2 relay while UE 2 may only support layer 3 relay. When UE 1 and UE 2 are out of network coverage or out of coverage of each other, they may be able to communicate with the UE-to-UE relay, but they cannot communicate with each other. With the help of the UE-to-UE relay that is capable of both layer 2 and layer 3 service, the UEs then can communicate with each other, even when the UEs support different relay capabilities (e.g., UE 1 only support layer 2 relay and UE 2 only supports layer 3 relay).

FIG. 3 and FIG. 4 further illustrate that because the security of communications is also important, some embodiments also allow the UEs that support different security algorithms (e.g., UE 1 support encryption algorithm A and UE 2 supports encryption algorithm B) to securely communicate with each other through the UE-to-UE relay. The security algorithm may include an encryption algorithm of a data encryption standard (DES), an encryption algorithm of an advanced encryption standard (AES), a ZU Chongzhi (ZUC) encryption algorithm, a (Ron Rivest, Adi Shamir and Leonard Adleman, RSA) encryption algorithm, or an encryption-less algorithm.

An alternative to the proposed solutions is to mandate the support of optional features in UEs, for example, specify in standards that all UEs are both layer-2 and layer-3 relay capable or to specify in standards that all UEs are both capable of encryption algorithm A and encryption B.

FIG. 5 illustrates a communication system 500 according to an embodiment of the present disclosure. The communication system 500 is configured to implement some embodiments of the disclosure. Some embodiments of the disclosure may be implemented into the communication system 500 using any suitably configured hardware and/or software. The communication system 500 includes an establisher 501 and an enabler 502. The establisher 501 is configured to establish a first connection link between a relay and a first user equipment (UE) having a first capability and configured to establish a second connection link between the relay and a second UE having a second capability different from the first capability. The enabler 502 is configured to enable communication between the first UE and the second UE through the relay. This can solve issues in the prior art and other issues. Further, the proposed some embodiments can allow multiple UEs with different capabilities to securely communicate with each other.

FIG. 6 illustrates a communication system 600 according to an embodiment of the present disclosure. The communication system 600 is configured to implement some embodiments of the disclosure. Some embodiments of the disclosure may be implemented into the communication system 600 using any suitably configured hardware and/or software. The communication system 600 may include a memory 601, a transceiver 602, and a processor 603 coupled to the memory 601 and the transceiver 602. The processor 603 may be configured to implement proposed functions, procedures and/or methods described in this description. Layers of radio interface protocol may be implemented in the processor 603. The memory 601 is operatively coupled with the processor 603 and stores a variety of information to operate the processor 603. The transceiver 602 is operatively coupled with the processor 603, and the transceiver 602 transmits and/or receives a radio signal. The processor 603 may include application-specific integrated circuit (ASIC), other chipset, logic circuit and/or data processing device. The memory 601 may include read-only memory (ROM), random access memory (RAM), flash memory, memory card, storage medium and/or other storage device. The transceiver 602 may include baseband circuitry to process radio frequency signals. When the embodiments are implemented in software, the techniques described herein can be implemented with modules (e.g., procedures, functions, and so on) that perform the functions described herein. The modules can be stored in the memory 601 and executed by the processor 603. The memory 601 can be implemented within the processor 603 or external to the processor 603 in which case those can be communicatively coupled to the processor 603 via various means as is known in the art.

In some embodiments, the processor 603 is configured to establish a first connection link between the relay and the first UE having a first capability, establish a second connection link between the relay and the second UE having a second capability different from the first capability. and enable communication between the first UE and the second UE through the relay. This can solve issues in the prior art and other issues. Further, the proposed some embodiments can allow multiple UEs with different capabilities to securely communicate with each other.

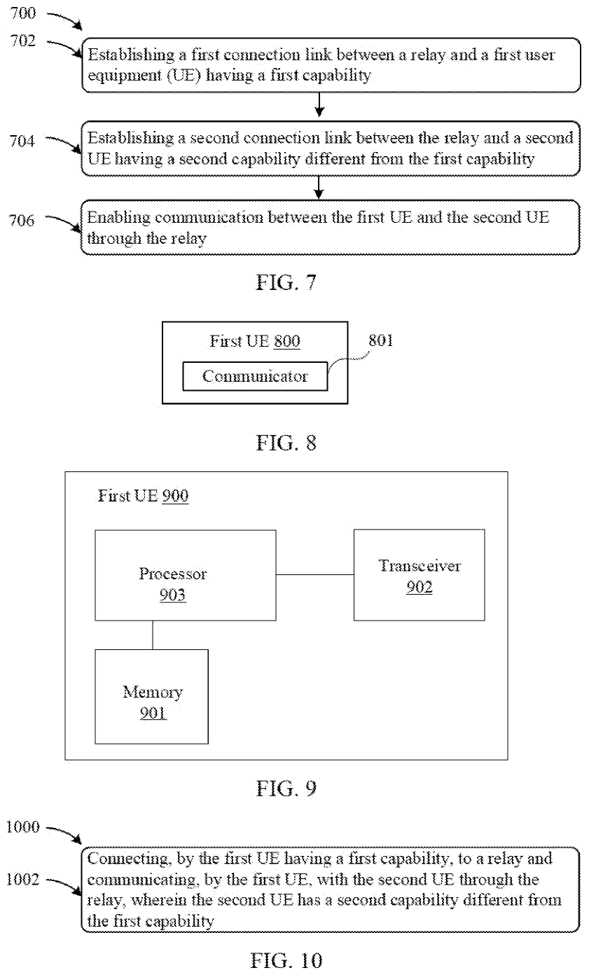

FIG. 7 illustrates a communication method 700 performed by a communication system according to an embodiment of the present disclosure. The communication method 700 performed by the communication system is configured to implement some embodiments of the disclosure. Some embodiments of the disclosure may be implemented into the communication method 700 performed by the communication system using any suitably configured hardware and/or software. In some embodiments, the communication method 700 performed by the communication system includes: an operation 702, establishing a first connection link between a relay and a first user equipment (UE) having a first capability, an operation 704, establishing a second connection link between the relay and a second UE having a second capability different from the first capability, and an operation 706, enabling communication between the first UE and the second UE through the relay. This can solve issues in the prior art and other issues. Further, the proposed some embodiments can allow multiple UEs with different capabilities to securely communicate with each other.

In some embodiments, the first capability and the second capability include services of different layers, respectively. In some embodiments, the first capability and the second capability include different security algorithms. respectively. In some embodiments, establishing the first connection link between the relay and the first UE includes establishing the first connection link between a first part of the relay and the first UE using a first service, and establishing the second connection link between the relay and the second UE includes establishing the second connection link between a second part of the relay and the second UE using a second service. In some embodiments, establishing the first connection link between the relay and the first UE includes establishing the first connection link between a second part of the relay and the first UE using a second service, and establishing the second connection link between the relay and the second UE includes establishing the second connection link between a first part of the relay and the second UE using a first service. In some embodiments, establishing the first connection link between the relay and the first UE includes establishing the first connection link between a first part and a second part of the relay and the first UE using a first service and a second service, and establishing the second connection link between the relay and the second UE includes establishing the second connection link between the first part and the second part of the relay and the second UE using the first service and the second service.

In some embodiments, the first part of the relay is a layer 3 relay, the first service is a layer 3 relay service, the second part of the relay is a layer 2 relay, and the second service is a layer 2 relay service. In some embodiments, in a case where the relay communicates with the first UE in a first format, the relay converts information received from the first UE into a second format, and the relay forwards the information in the second format to the second UE. In some embodiments, in a case where the relay communicates with the first UE in a second format, the relay converts information received from the first UE into a first format, and the relay forwards the information in the first format to the second UE.

In some embodiments, the first format is a layer 3 format, and the second format is a layer 2 format. In some embodiments, a communication between the first UE and the second UE is secured in a hop-by-hop manner. In some embodiments, the first UE is configured to encrypt a communication with the replay using a first encryption algorithm. In some embodiments, the relay is configured to decrypt the communication from the first UE using the first encryption algorithm. In some embodiments, the relay is configured to re-encrypt the communication from the first UE using a second encryption algorithm and forward to the second UE with the communication. In some embodiments, the second UE is configured to decrypt the communication from the relay using the second encryption algorithm.

FIG. 8 illustrates a first UE 800 according to an embodiment of the present disclosure. The first UE 800 is configured to implement some embodiments of the disclosure. Some embodiments of the disclosure may be implemented into the first UE 800 using any suitably configured hardware and/or software. The first UE 800 includes a communicator 801 connected to a relay and configured to communicate with the second UE through the relay, wherein the second UE has a second capability different from a first capability of the first UE. This can solve issues in the prior art and other issues. Further, the proposed some embodiments can allow multiple UEs with different capabilities to securely communicate with each other.

FIG. 9) illustrates a first UE 900 according to an embodiment of the present disclosure. The first UE 900 is configured to implement some embodiments of the disclosure. Some embodiments of the disclosure may be implemented into the first UE 900 using any suitably configured hardware and/or software. The first UE 900 may include a memory 901, a transceiver 902, and a processor 903 coupled to the memory 901 and the transceiver 902. The processor 903 may be configured to implement proposed functions, procedures and/or methods described in this description. Layers of radio interface protocol may be implemented in the processor 903. The memory 901 is operatively coupled with the processor 903 and stores a variety of information to operate the processor 903. The transceiver 902 is operatively coupled with the processor 903, and the transceiver 902 transmits and/or receives a radio signal. The processor 903 may include application-specific integrated circuit (ASIC), other chipset, logic circuit and/or data processing device. The memory 901 may include read-only memory (ROM), random access memory (RAM). flash memory, memory card, storage medium and/or other storage device. The transceiver 902 may include baseband circuitry to process radio frequency signals. When the embodiments are implemented in software, the techniques described herein can be implemented with modules (e.g., procedures, functions, and so on) that perform the functions described herein. The modules can be stored in the memory 901 and executed by the processor 903. The memory 901 can be implemented within the processor 903 or external to the processor 903 in which case those can be communicatively coupled to the processor 903 via various means as is known in the art.

In some embodiments, the processor 930 having a first capability is connected to the relay and is configured to communicate with the second UE through the relay, wherein the second UE has a second capability different from the first capability. This can solve issues in the prior art and other issues. Further, the proposed some embodiments can allow multiple UEs with different capabilities to securely communicate with each other.

FIG. 10 illustrates a communication method 1000 performed by a first UE according to an embodiment of the present disclosure. The communication method 1000 performed by the first UE is configured to implement some embodiments of the disclosure. Some embodiments of the disclosure may be implemented into the communication method 1000 performed by the first UE using any suitably configured hardware and/or software. In some embodiments, the communication method 1000 performed by the first UE includes: an operation 1002, connecting, by the first UE having a first capability, to a relay and communicating, by the first UE, with the second UE through the relay, wherein the second UE has a second capability different from the first capability. This can solve issues in the prior art and other issues. Further, the proposed some embodiments can allow multiple UEs with different capabilities to securely communicate with each other.

In some embodiments, the first capability and the second capability include services of different layers, respectively. In some embodiments, the first capability and the second capability include different security algorithms, respectively. In some embodiments, connecting by the first UE to the relay includes connecting by the first UE to a first part of the relay using a first service and/or connecting by the first UE to a second part of the relay using a second service. In some embodiments, the first part of the relay is a layer 3 relay, and the first service is a layer 3 relay service: and/or the second part of the relay is a layer 2 relay, and the second service is a layer 2 relay service.

In some embodiments, the first UE is configured to communicate with the relay in a first format and/or a second format. In some embodiments, the first format is a layer 3 format, and/or the second format is a layer 2 format. In some embodiments, the first UE is configured to communicate with the second UE in a hop-by-hop manner. In some embodiments, the first UE is configured to encrypt the communication with the relay using a first encryption algorithm and/or a second encryption algorithm.

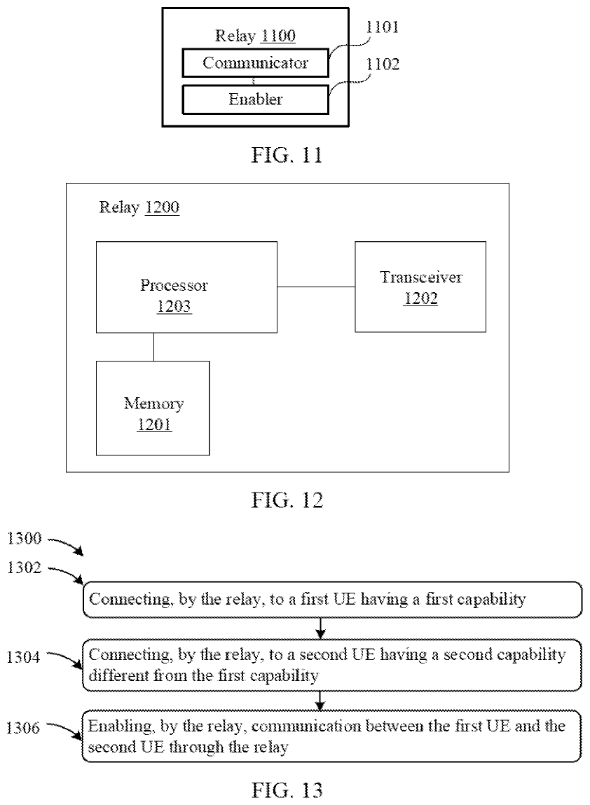

FIG. 11 illustrates a relay 1100 according to an embodiment of the present disclosure. The relay 1100 is configured to implement some embodiments of the disclosure. Some embodiments of the disclosure may be implemented into the relay 1100 using any suitably configured hardware and/or software. The relay 1100 includes a communicator 1101 and an enabler 1102. The communicator 1101 is connected to a first UE having a first capability and connected to a second UE having a second capability different from the first capability. The enabler 1102 is configured to enable communication between the first UE and the second UE through the relay. This can solve issues in the prior art and other issues. Further, the proposed some embodiments can allow multiple UEs with different capabilities to securely communicate with each other.

FIG. 12 illustrates a relay 1200 according to an embodiment of the present disclosure. The relay 1200 is configured to implement some embodiments of the disclosure. Some embodiments of the disclosure may be implemented into the relay 1200 using any suitably configured hardware and/or software. The relay 1200 may include a memory 1201, a transceiver 1202, and a processor 1203 coupled to the memory 1201 and the transceiver 1202. The processor 1203 may be configured to implement proposed functions, procedures and/or methods described in this description. Layers of radio interface protocol may be implemented in the processor 1203. The memory 1201 is operatively coupled with the processor 1203 and stores a variety of information to operate the processor 1203. The transceiver 1202 is operatively coupled with the processor 1203, and the transceiver 1202 transmits and/or receives a radio signal. The processor 1203 may include application-specific integrated circuit (ASIC), other chipset, logic circuit and/or data processing device. The memory 1201 may include read-only memory (ROM), random access memory (RAM), flash memory, memory card, storage medium and/or other storage device. The transceiver 602 may include baseband circuitry to process radio frequency signals. When the embodiments are implemented in software, the techniques described herein can be implemented with modules (e.g., procedures, functions, and so on) that perform the functions described herein. The modules can be stored in the memory 1201 and executed by the processor 1203. The memory 1201 can be implemented within the processor 1203 or external to the processor 1203 in which case those can be communicatively coupled to the processor 1203 via various means as is known in the art.

In some embodiments, the processor 1203 is connected to the first UE having a first capability and connected to the second UE having a second capability different from the first capability. The processor 1203 is configured to enable communication between the first UE and the second UE through the relay. This can solve issues in the prior art and other issues. Further, the proposed some embodiments can allow multiple UEs with different capabilities to securely communicate with each other.

FIG. 13 illustrates a communication method 1300 performed by a relay according to an embodiment of the present disclosure. The communication method 1300 performed by the relay is configured to implement some embodiments of the disclosure. Some embodiments of the disclosure may be implemented into the communication method 1300 performed by the relay using any suitably configured hardware and/or software. In some embodiments, the communication method 1300 performed by the relay includes: an operation 1302, connecting, by the relay, to a first UE having a first capability, an operation 1304, connecting, by the relay, to a second UE having a second capability different from the first capability, and an operation 1306, enabling, by the relay, communication between the first UE and the second UE through the relay. This can solve issues in the prior art and other issues. Further, the proposed some embodiments can allow multiple UEs with different capabilities to securely communicate with each other.

In some embodiments, the first capability and the second capability include services of different layers, respectively. In some embodiments, the first capability and the second capability include different security algorithms, respectively. In some embodiments, connecting, by the relay, to the first UE includes connecting by a first part of the relay to the first UE using a first service, and connecting, by the relay, to the second UE includes connecting by a second part of the relay to the second UE using a second service.

In some embodiments, connecting, by the relay, to the first UE includes connecting by a second part of the relay to the first UE using a second service, and connecting, by the relay, to the second UE includes connecting by a first part of the relay to the second UE using a first service. In some embodiments, connecting, by the relay, to the first UE includes connecting by a first part and a second part of the relay to the first UE using a first service and a second service, and connecting, by the relay, to the second UE includes connecting by the first part and the second part of the relay to the second UE using the first service and the second service.

In some embodiments, the first part of the relay is a layer 3 relay, the first service is a layer 3 relay service, the second part of the relay is a layer 2 relay, and the second service is a layer 2 relay service. In some embodiments, in a case where the relay communicates with the first UE in a first format, the relay converts information received from the first UE into a second format, and the relay forwards the information in the second format to the second UE. In some embodiments, in a case where the relay communicates with the first UE in a second format, the relay converts information received from the first UE into a first format, and the relay forwards the information in the first format to the second UE. In some embodiments, the first format is a layer 3 format, and the second format is a layer 2 format.

In some embodiments, the first UE is configured to communicate with the second UE in a hop-by-hop manner. In some embodiments, the relay is configured to decrypt the communication from the first UE using a first encryption algorithm. In some embodiments, the relay is configured to re-encrypt the communication from the first UE using a second encryption algorithm and forward to the second UE with the communication.

In summary, in some embodiments, in 5G proximity service, multiple UEs out of network coverage can be connected by a UE-to-UE relay for communicating with each other. The UE-to-UE relay can be defined as capable of providing relaying of UE-to-UE communication using L2 relay service. L3 service, or both. The UE-to-UE relay may broadcast its capabilities (e.g., L3 relay or L2 relay) and UEs wishing to connect to the UE-to-UE relay may select L3 or L2 based on UE capabilities. UEs may support L2, L3, or both relay capabilities. Some embodiments allow UEs with different relay capabilities (e.g., only can connect to a UE-to-UE relay using L3) to communicate with each other through the UE-to-UE relay, for example UE 1 is L3-capable only and UE2 is L2-capable only. Some embodiments further allow UEs with different security capabilities to securely communicate with each other, for example when UE 1 and UE 2 are supporting different security algorithms, such that UE 1 only supports a first cipher algorithm (e.g., . AES encryption algorithm) and UE 2 only supports a second cipher algorithm (e.g., ZUC encryption algorithm).

Commercial interests for some embodiments are as follows. 1. Solve issues in the prior art. 2. Solve other issues. 3. Allow multiple UEs with different capabilities to securely communicate with each other. 4. Provide a good communication performance. 6. Provide high reliability. 7. Some embodiments of the present disclosure are used by chipset vendors, video system development vendors, automakers including cars, trains, trucks, buses, bicycles, moto-bikes, helmets, and etc., drones (unmanned aerial vehicles), smartphone makers, communication devices for public safety use. AR/VR/MR device maker for example gaming, conference/seminar, education purposes. Some embodiments of the present disclosure are a combination of “techniques/processes” that can be adopted in video standards to create an end product. Some embodiments of the present disclosure propose technical mechanisms. The at least one proposed solution, method, system, and apparatus of some embodiments of the present disclosure may be used for current and/or new/future standards regarding communication systems such as a UE, a relay, and/or a communication system. Compatible products follow at least one proposed solution, method, system, and apparatus of some embodiments of the present disclosure. The proposed solution, method, system, and apparatus are widely used in a UE, a relay, and/or a communication system. With the implementation of the at least one proposed solution, method, system, and apparatus of some embodiments of the present disclosure, at least one modification to communication methods and apparatus are considered for standardizing.

FIG. 14 is an example of a computing device 1400 according to an embodiment of the present disclosure. Any suitable computing device can be used for performing the operations described herein. For example. FIG. 14 illustrates an example of the computing device 1400 that can implement apparatuses and methods of the above embodiments of FIGS. 2 to 13, using any suitably configured hardware and/or software. In some embodiments, the computing device 1400 can include a processor 1412 that is communicatively coupled to a memory 1414 and that executes computer-executable program code and/or accesses information stored in the memory 1414. The processor 1412 may include a microprocessor, an application-specific integrated circuit (“ASIC”). a state machine, or other processing device. The processor 1412 can include any of a number of processing devices, including one. Such a processor can include or may be in communication with a computer-readable medium storing instructions that, when executed by the processor 1412, cause the processor to perform the operations described herein.

The memory 1414 can include any suitable non-transitory computer-readable medium. The computer-readable medium can include any electronic, optical, magnetic, or other storage device capable of providing a processor with computer-readable instructions or other program code. Non-limiting examples of a computer-readable medium include a magnetic disk, a memory chip, a read-only memory (ROM), a random access memory (RAM), an application specific integrated circuit (ASIC), a configured processor, optical storage, magnetic tape or other magnetic storage, or any other medium from which a computer processor can read instructions. The instructions may include processor-specific instructions generated by a compiler and/or an interpreter from code written in any suitable computer-programming language, including, for example, C, C++, C#, visual basic, java, python, perl, javascript, and actionscript.

The computing device 1400 can also include a bus 1416. The bus 1416 can communicatively couple one or more components of the computing device 1400. The computing device 1400 can also include a number of external or internal devices such as input or output devices. For example, the computing device 1400 is illustrated with an input/output (“I/O”) interface 1418 that can receive input from one or more input devices 1420 or provide output to one or more output devices 1422. The one or more input devices 1420 and one or more output devices 1422 can be communicatively coupled to the I/O interface 1418. The communicative coupling can be implemented via any suitable manner (e.g., a connection via a printed circuit board, connection via a cable, communication via wireless transmissions, etc.). Non-limiting examples of input devices 1420 include a touch screen (e g., one or more cameras for imaging a touch area or pressure sensors for detecting pressure changes caused by a touch), a mouse, a keyboard, or any other device that can be used to generate input events in response to physical actions by a user of a computing device. Non-limiting examples of output devices 1422 include a liquid crystal display (LCD) screen, an external monitor, a speaker, or any other device that can be used to display or otherwise present outputs generated by a computing device.

The computing device 1400 can execute program code that configures the processor 1412 to perform one or more of the operations described above with respect to methods of the above embodiments of FIGS. 2 to 13. The program code may be resident in the memory 1414 or any suitable computer-readable medium and may be executed by the processor 1412 or any other suitable processor.

The computing device 1400 can also include at least one network interface device 1424. The network interface device 1424 can include any device or group of devices suitable for establishing a wired or wireless data connection to one or more data networks 1428. Non limiting examples of the network interface device 1424 include an Ethernet network adapter, a modem. and/or the like. The computing device 1400 can transmit messages as electronic or optical signals via the network interface device 1424.

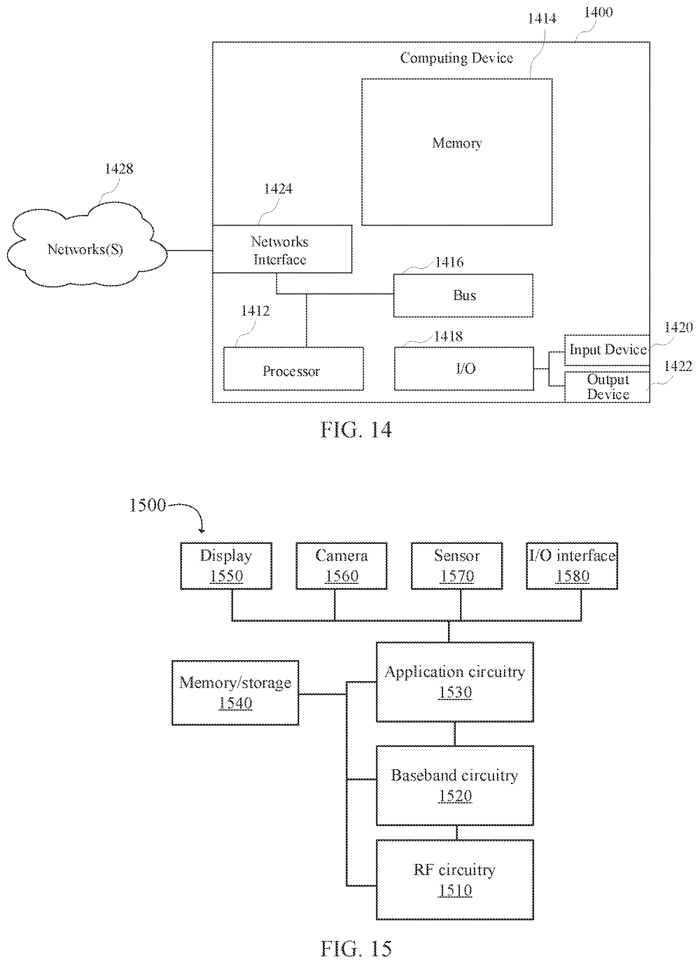

FIG. 15 is a block diagram of an example of a communication system 1500 according to an embodiment of the present disclosure. Embodiments described herein may be implemented into the communication system 1500 using any suitably configured hardware and/or software. FIG. 15 illustrates the communication system 1500 including a radio frequency (RF) circuitry 1510, a baseband circuitry 1520, an application circuitry 1530, a memory/storage 1540, a display 1550, a camera 1560), a sensor 1570, and an input/output (I/O) interface 1580, coupled with each other at least as illustrated.

The application circuitry 1530 may include a circuitry such as, but not limited to, one or more single-core or multi-core processors. The processors may include any combination of general-purpose processors and dedicated processors, such as graphics processors, application processors. The processors may be coupled with the memory/storage and configured to execute instructions stored in the memory/storage to enable various applications and/or operating systems running on the system. The communication system 1500 can execute program code that configures the application circuitry 1530 to perform one or more of the operations described above with respect to methods of the above embodiments of FIGS. 2 to 13. The program code may be resident in the application circuitry 1530 or any suitable computer-readable medium and may be executed by the application circuitry 1530 or any other suitable processor.

The baseband circuitry 1520 may include circuitry such as, but not limited to, one or more single-core or multi-core processors. The processors may include a baseband processor. The baseband circuitry may handle various radio control functions that may enable communication with one or more radio networks via the RF circuitry. The radio control functions may include, but are not limited to, signal modulation, encoding, decoding, radio frequency shifting, etc. In some embodiments, the baseband circuitry may provide for communication compatible with one or more radio technologies. For example, in some embodiments, the baseband circuitry may support communication with an evolved universal terrestrial radio access network (EUTRAN) and/or other wireless metropolitan area networks (WMAN), a wireless local area network (WLAN), a wireless personal area network (WPAN). Embodiments in which the baseband circuitry is configured to support radio communications of more than one wireless protocol may be referred to as multi-mode baseband circuitry.

In various embodiments, the baseband circuitry 1520 may include circuitry to operate with signals that are not strictly considered as being in a baseband frequency. For example, in some embodiments, baseband circuitry may include circuitry to operate with signals having an intermediate frequency, which is between a baseband frequency and a radio frequency. The RF circuitry 1510 may enable communication with wireless networks using modulated electromagnetic radiation through a non-solid medium. In various embodiments, the RF circuitry may include switches, filters, amplifiers, etc. to facilitate the communication with the wireless network. In various embodiments, the RF circuitry 1510 may include circuitry to operate with signals that are not strictly considered as being in a radio frequency. For example, in some embodiments. RF circuitry may include circuitry to operate with signals having an intermediate frequency, which is between a baseband frequency and a radio frequency.

In various embodiments, the transmitter circuitry, control circuitry, or receiver circuitry discussed above with respect to apparatuses and methods of the above embodiments of FIGS. 2 to 13 may be embodied in whole or in part in one or more of the RF circuitry, the baseband circuitry, and/or the application circuitry. As used herein, “circuitry” may refer to, be part of, or include an application specific integrated circuit (ASIC), an electronic circuit, a processor (shared, dedicated, or group), and/or a memory (shared, dedicated, or group) that execute one or more software or firmware programs, a combinational logic circuit, and/or other suitable hardware components that provide the described functionality. In some embodiments, the electronic device circuitry may be implemented in, or functions associated with the circuitry may be implemented by, one or more software or firmware modules. In some embodiments, some or all of the constituent components of the baseband circuitry, the application circuitry, and/or the memory/storage may be implemented together on a system on a chip (SOC). The memory/storage 1540 may be used to load and store data and/or instructions, for example, for system. The memory/storage for one embodiment may include any combination of suitable volatile memory, such as dynamic random access memory (DRAM)), and/or non-volatile memory, such as flash memory.

In various embodiments, the I/O interface 1580 may include one or more user interfaces designed to enable user interaction with the system and/or peripheral component interfaces designed to enable peripheral component interaction with the system. User interfaces may include. but are not limited to a physical keyboard or keypad, a touchpad, a speaker, a microphone, etc. Peripheral component interfaces may include, but are not limited to, a non-volatile memory port, a universal serial bus (USB) port, an audio jack, and a power supply interface. In various embodiments, the sensor 1570) may include one or more sensing devices to determine environmental conditions and/or location information related to the system. In some embodiments, the sensors may include, but are not limited to, a gyro sensor, an accelerometer, a proximity sensor, an ambient light sensor, and a positioning unit. The positioning unit may also be part of, or interact 30) with, the baseband circuitry and/or RF circuitry to communicate with components of a positioning network, e.g., a global positioning system (GPS) satellite.

In various embodiments, the display 1550 may include a display, such as a liquid crystal display and a touch screen display. In various embodiments, the communication system 1500 may be a mobile computing device such as, but not limited to, a laptop computing device, a tablet computing device, a netbook, an ultrabook, a smartphone, an AR/VR glasses, etc. In various embodiments, system may have more or less components, and/or different architectures. Where appropriate, methods described herein may be implemented as a computer program. The computer program may be stored on a storage medium, such as a non-transitory storage medium.

A person having ordinary skill in the art understands that each of the units, algorithm, and steps described and disclosed in the embodiments of the present disclosure are realized using electronic hardware or combinations of software for computers and electronic hardware. Whether the functions run in hardware or software depends on the condition of application and design requirement for a technical plan. A person having ordinary skill in the art can use different ways to realize the function for each specific application while such realizations should not go beyond the scope of the present disclosure. It is understood by a person having ordinary skill in the art that he/she can refer to the working processes of the system, device, and unit in the above-mentioned embodiment since the working processes of the above-mentioned system, device, and unit are basically the same. For easy description and simplicity, these working processes will not be detailed.

It is understood that the disclosed system, device, and method in the embodiments of the present disclosure can be realized with other ways. The above-mentioned embodiments are exemplary only. The division of the units is merely based on logical functions while other divisions exist in realization. It is possible that a plurality of units or components are combined or integrated in another system. It is also possible that some characteristics are omitted or skipped. On the other hand, the displayed or discussed mutual coupling, direct coupling, or communicative coupling operate through some ports, devices, or units whether indirectly or communicatively by ways of electrical, mechanical, or other kinds of forms.

The units as separating components for explanation are or are not physically separated. The units for display are or are not physical units, that is, located in one place or distributed on a plurality of network units. Some or all of the units are used according to the purposes of the embodiments. Moreover, each of the functional units in each of the embodiments can be integrated in one processing unit, physically independent, or integrated in one processing unit with two or more than two units.

If the software function unit is realized and used and sold as a product, it can be stored in a readable storage medium in a computer. Based on this understanding, the technical plan proposed by the present disclosure can be essentially or partially realized as the form of a software product. Or, one part of the technical plan beneficial to the conventional technology can be realized as the form of a software product. The software product in the computer is stored in a storage medium, including a plurality of commands for a computational device (such as a personal computer, a server, or a network device) to run all or some of the steps disclosed by the embodiments of the present disclosure. The storage medium includes a USB disk, a mobile hard disk, a read-only memory (ROM), a random access memory (RAM), a floppy disk, or other kinds of media capable of storing program codes.

While the present disclosure has been described in connection with what is considered the most practical and preferred embodiments, it is understood that the present disclosure is not limited to the disclosed embodiments but is intended to cover various arrangements made without departing from the scope of the broadest interpretation of the appended claims.

1-15. (canceled)

16. A communication method by a first user equipment (UE), comprising:
connecting, by the first UE having a first capability, to a relay; and
communicating, by the first UE, with a second UE through the relay, wherein the second UE has a second capability different from the first capability.

17. The method of claim 16, wherein the first capability and the second capability comprise services of different layers, respectively.

18. The method of claim 16, wherein the first capability and the second capability comprise different security algorithms, respectively.

19. The method of claim 16, wherein connecting by the first UE to the relay comprises:
connecting by the first UE to a first part of the relay using a first service and/or connecting by the first UE to a second part of the relay using a second service.

20. The method of claim 18, wherein a first part of the relay is a layer 3 relay, and a first service is a layer 3 relay service; and/or a second part of the relay is a layer 2 relay, and the second service is a layer 2 relay service.

21. The method of claim 16, wherein the first UE is configured to communicate with the relay in a first format and/or a second format.

22. The method of claim 21, wherein the first format is a layer 3 format, and/or the second format is a layer 2 format.

23. The method of claim 16, wherein the first UE is configured to communicate with the second UE in a hop-by-hop manner.

24. The method of claim 16, wherein the first UE is configured to encrypt the communication with the relay using a first encryption algorithm and/or a second encryption algorithm.

25. A communication method by a relay, comprising:
connecting, by the relay, to a first UE having a first capability:
connecting, by the relay, to a second UE having a second capability different from the first capability; and
enabling, by the relay, communication between the first UE and the second UE through the relay.

26. The method of claim 25, wherein the first capability and the second capability comprise services of different layers, respectively.

27. The method of claim 25, wherein the first capability and the second capability comprise different security algorithms, respectively.

28. The method of claim 25, wherein connecting, by the relay, to the first UE comprises connecting by a first part of the relay to the first UE using a first service, and connecting, by the relay, to the second UE comprises connecting by a second part of the relay to the second UE using a second service.

29. The method of claim 25, wherein connecting, by the relay, to the first UE comprises connecting by a second part of the relay to the first UE using a second service, and connecting, by the relay, to the second UE comprises connecting by a first part of the relay to the second UE using a first service.

30. The method of claim 25, wherein connecting, by the relay, to the first UE comprises connecting by a first part and a second part of the relay to the first UE using a first service and a second service, and connecting, by the relay, to the second UE comprises connecting by the first part and the second part of the relay to the second UE using the first service and the second service.

31. The method of claim 28, wherein the first part of the relay is a layer 3 relay, the first service is a layer 3 relay service, the second part of the relay is a layer 2 relay, and the second service is a layer 2 relay service.

32. The method of claim 25, wherein in a case where the relay communicates with the first UE in a first format, the relay converts information received from the first UE into a second format, and the relay forwards the information in the second format to the second UE.

33. The method of claim 25, wherein in a case where the relay communicates with the first UE in a second format, the relay converts information received from the first UE into a first format, and the relay forwards the information in the first format to the second UE.

34-35. (canceled)

36. The method of claim 25, wherein the relay is configured to decrypt the communication from the first UE using a first encryption algorithm.

37. The method of claim 36, wherein the relay is configured to re-encrypt the communication from the first UE using a second encryption algorithm and forward to the second UE with the communication.

38-48. (canceled)
